(19) United States
(12) Patent Application Publication
(10) Pub. No.: US 2010/0254578 A1
(43) Pub. Date: Oct. 7, 2010

(54) HANDWRITING AUTHENTICATION METHOD, SYSTEM AND COMPUTER PROGRAM

(76) Inventors: Mercedeh Modir Shanechi, Toronto (CA); Thomas Tak Kin Chau, Toronto (CA); Ervin Sejdic, Toronto (CA)

Correspondence Address: MILLER THOMPSON, LLP, Scotia Plaza, 40 King Street West, Suite 5800, TORONTO, ON, M5H 3S1, CA

(21) Appl. No.: 12/754,062

(22) Filed: Apr. 5, 2010

Related U.S. Application Data
(60) Provisional application No. 61/167,024, filed on Apr. 6, 2009.

(51) Int. Cl. G06K 9/00

(52) U.S. Cl. 382/119

(57) ABSTRACT

A method of associating handwriting with an individual, or authenticating a document or transaction based on handwriting of one or more individuals is provided, the method including (a) collecting by operation of a handwriting instrument, biometric data from a plurality of instances of handwriting of at least one individual, such biometric data including grip pressure and optionally including axial pressure, so as to create a set of handwriting biometric data elements; (b) modeling the handwriting biometric data elements to create, or facilitate the creation of, a functional characteristic model for the handwriting of each of the at least one individual; and (c) associating each of one or more target instances of handwriting with an individual associated with such handwriting based on the functional characteristic model, and optionally based on such association(s) authenticating a document or transaction. A handwriting instrument is also provided that includes an array of sensors that enable the capture of handwriting biometric data across a plurality of instances of handwriting of at least one individual, such array being operable to sense grip pressure and optionally axial pressure, wherein said array is disposed in substantially all of the area of the surface of a handwriting instrument where a user is likely to contact the handwriting instrument during writing, wherein the array is connected or connectable to a computer for analyzing the handwriting biometric data, and enabling based on such analysis association of handwriting with an individual, or authentication of a document or transaction based on handwriting of one or more individuals.

### PRIORITY

The present invention claims priority from U.S. Provisional Patent Application No. 61/167,024 filed Apr. 6, 2009.

### FIELD OF INVENTION

This invention relates in general to the field of signature authentication through the use of biometric information and more particularly to a methods, systems and computer programs designed to authenticate the identity of a user by receiving the signature from the user.

### BACKGROUND OF THE INVENTION

There is a need for signature authentication as a person's signature continues to be used as a way to identify an individual for a variety of purposes. Attempts to detect forgeries have initially been made by visually comparing a genuine signature with a subsequently written one. Visual comparisons of signatures do not tend to be very accurate and an expert forger is able to duplicate the appearance of a person's signature.

As visual comparisons of signatures generally have not been a satisfactory method to detect forgery, the prior art discloses improved signature authentication systems that detect further elements of a signature. Many of these systems measure acceleration or speed used by the person signing; however, speed is one of the most variable components in written movements and can be deliberately modified. Other systems measure axial pressure, angle of the writing utensil or movements along an x-axis, y-axis and/or z-axis in an attempt to further improve signature authentication. These recent developments are exemplified in the following patents.

U.S. Pat. No. 4,128,829 of Herbst et al. discloses personal identification via computer based signature analysis. Acceleration of the writing utensil and axial pressure are measured and these samples are segmented and correlated to obtain the maximum possible correlation. The correlations are weighted and combined with individual correlation statistics for all segments.

U.S. Pat. No. 4,789,934 of Gundersen et al. discloses a verification algorithm where the user signs at least once, and two acceleration components and the rate of change of axial pressure are measured. A coherence operation is performed on segments of sample and reference pressure signals and on segments of the sample and reference acceleration signals thereby obtaining pressure and acceleration coherence scores. The total coherence score is computed then compared with a coherence threshold to determine signature validity.

U.S. Pat. No. 5,018,208 of Gladstone discloses an apparatus that can be attached to a pen that records finger pressure exerted by the user. An attachment is added to the writing utensil where the fingers meet the pen, and pressure exerted by three fingers of a user is calculated for use in a verification process.

U.S. Pat. No. 5,774,571 of Marshall discloses a writing instrument with sensors to detect various biometrics. The writing instrument collects grip pressure through a sleeve attached around the writing instrument barrel; writing pressure through contact with the surface; X, Y, and Z co-ordinates through use of a gyroscope; and speed (velocity).

U.S. Pat. No. 5,781,661 issued to Hiraiwa et al. teaches an apparatus that can be attached to a pen and can record information regarding the user's handwriting. X, Y and Z axis acceleration sensors are disclosed as is a time element and index finger pressure.

U.S. Pat. No. 6,148,093 issued to McConnell et al. discloses a signature authentication method that takes as input: movement and rotation around the X, Y and Z axes, and time. Temperature and pressure are also disclosed as an optional addition to the data file. Authentication of a sample is completed against the original. The movement around all three dimensions is attempting to reduce the likelihood that a forgery would match the original.

U.S. Pat. No. 7,415,141 of Okazaki teaches a signature authentication method where a “dictionary” of signature samples is collected. When a sample signature is entered for authentication it can either be compared against the dictionary data or average of the dictionary samples. If it is within the threshold it is accepted, otherwise it is rejected as a forgery.

U.S. patent application Ser. No. 10/924,301 by Kim teaches a method and system for capturing and authenticating biometric information from a writing instrument. The biometric information used consists of the angle of the pen-tilt; the pressure applied to the writing surface; the speed of the signature and other such characteristics. The writing instrument captures two or more forms of biometric information and this information is encrypted and stored as the sample signature. A reference signature can then be compared against the sample to determine if it is a forgery.

### BRIEF DESCRIPTION OF THE DRAWINGS

The invention will be better understood and objects of the invention will become apparent when consideration is given to the following detailed description thereof. Such description makes reference to the annexed drawings wherein:

FIG. 1 illustrates a modified writing instrument in accordance with the present invention.

FIG. 2 illustrates a data collection instrument in accordance with one aspect of the present invention.

FIG. 3 illustrates the operation of the parameter extraction of each signature in accordance with one aspect of the present invention.

FIG. 4 is a flow diagram illustrating the steps in the data collection and authentication method in accordance with the present invention.

FIG. 5 illustrates in chart form obtaining the point-by-point differences of the test signature compared with the mean of the model in one embodiment of the present invention.

FIG. 6 illustrates in chart form the detection of a real signature in accordance with one aspect of the present invention.

FIG. 7 illustrates in chart form the detection of a forgery in accordance with one aspect of the present invention.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

The present invention provides a method of associating handwriting with an individual, or authenticating a document or transaction based on handwriting of one or more individuals, comprising the steps of: (a) collecting by operation of a handwriting instrument, biometric data from a plurality of instances of handwriting of at least one individual, such biometric data including grip pressure and optionally including axial pressure, so as to create a set of handwriting biometric data elements; (b) modeling the handwriting biometric data elements to create, or facilitate the creation of, a functional characteristic model for the handwriting of each of the at least one individual; and (c) associating each of one or more target instances of handwriting with an individual associated with such handwriting based on the functional characteristic model, and optionally based on such association(s) authenticating a document or transaction.

The biometric data is obtained for an area, or substantially all of an area, where the individual contacts the handwriting instrument during writing. In one aspect of the invention, as explained below, the functional characteristic model includes adjustability of specificity and/or sensitivity.

The handwriting apparatus of the present invention includes an array of sensors that enable the capture of handwriting biometric data across a plurality of instances of handwriting of at least one individual, such array being operable to sense grip pressure and optionally axial pressure, wherein said array is disposed in substantially all of the area of the surface of a handwriting instrument where a user is likely to contact the handwriting instrument during writing, wherein the array is connected or connectable to a computer for analyzing the handwriting biometric data, and enabling based on such analysis association of handwriting with an individual, or authentication of a document or transaction based on handwriting of one or more individuals.

The present invention provides a system, method and computer program that collects biometric data from individuals' instances of handwriting (such as a signature) and is operable to process and model the biometric information for authentication or handwriting recognition purposes.

It should be understood that there are multiple references to “signature” or “signatures” in this disclosure, as a signature is an example of handwriting where authentication thereof is a particular concern. It should be understood that the present invention, and the advantages that it presents, relate to handwriting and not signatures, and references to a “signature” or “signatures” should be understood to apply to handwriting generally.

In one aspect of the invention, a system, method and computer program is provided for authentication of handwriting based on handwriting biometric data associated with a user, such handwriting biometric data, including grip pressure and optionally axial pressure, wherein (a) the biometric data is analyzed to create a functional characteristic model for the user, and (b) an instance of handwriting is authenticated for the user by comparing data derived from the instance of handwriting to the functional characteristic model. The functional characteristic model is derived by means of statistical analysis of the handwriting biometric data, as further explained below. In one aspect of the invention, if the results of the comparison of the instance of handwriting to the functional characteristic model are within an acceptable range that is defined, the instance of handwriting is determined to be the handwriting of the user, otherwise if the results are outside the acceptable range the instance of handwriting is rejected as not being that of the user.

In one aspect of the present invention, one part of the functional characteristic model is a threshold level that is adjustable to achieve a balance of specificity and sensitivity. One of the disadvantages of the prior art is that tolerance level is generally rigid and therefore adjustment for particular applications for example are often difficult. Other prior art applications erred on the side of specificity or in some cases sensitivity but the prior art generally does not provide solutions that enable the achievement of a balance between specificity and sensitivity, based on the relevant circumstances. In accordance with the present invention, the method, system and computer program allows for the adjustability of the threshold level to stress either specificity or sensitivity in accordance with the security level needed for the authentication of handwriting in the specific case. This aspect of the invention is discussed in greater detail below.

The authentication algorithm and/or a software utility that implements the authentication algorithm described herein, or the processes enabled by such algorithm, can be based on grip force profiles alone or the combined grip force and axial force profiles. The combined algorithm specifies that both the grip force profile and the axial force profile of the test signature must fall within the distribution of the real signature model in order for the test to be detected as authentic/real. When the combined algorithm is utilized for authentication, the sensitivity drops from 95.35% to 89.75% (the algorithm has become more stringent) yet the specificity of the authentication improves from 90.86% to 94.86%. Specificity is often the more desirable statistic since it is crucial to detect the forgery.

In one aspect of the invention, a computer program is provided that operable on a computer to analyze and calculate the functional characteristic model, as described below.

It should be understood that the present invention applies to authentication and characterization of handwriting generally and not just to signatures. The discussion of the invention below refers in numerous places to “signatures” but it should be understood that this is an example of handwriting only. It is also noted that some individuals exhibit on average greater consistency in their writing of certain words than they do in making their signature. Thus handwriting generally can have significant biometric value.

In another aspect of the invention, a writing apparatus is provided that operable to collect grip force data so as to define a total grip force profile. The prior art has focused on using specific aspects of grip force, for example measuring grip force at the finger tip. In accordance with the present invention, it has been discovered that grip force exerted by the hand of a user at the various points of contact made between the hand and the writing instrument defines biometric information unique to the particular user. The measurement and analysis of this biometric information across the various points of contact refers to the “total grip force profile” that extends to substantially all the points of contact between a user's hand and a writing instrument.

Grip force as a biometric indicator varies over time during a signature or writing, and therefore in one aspect of the invention the total grip force profile has a time dimension in that grip force over the plurality of points of contact is measured over time during signature.

One of the aspects of the present invention is that axial force may also be used a biometric indicator in conjunction with grip force. For example, axial force may be synchronized with grip force by measuring axial force and grip force over time during signature.

In yet another aspect of the present invention, a writing instrument is provided that is operable to collect grip pressure data for generation of a total grip force profile. The writing instrument may also be able to measure the axial force as well.

The adjustability of the tolerance levels—by adjusting specificity and sensitivity of the model or by synchronizing the axial force with the grip force and creating a further dimension to ensure reliability of the model. This greater flexibility seems to add further novelty.

There is further need for such a method, system and computer program that is relatively user-friendly to initiate. It should be understood that an individual's signature generally varies over time, which in prior art inventions generally results in acceptance of the signature reaching unacceptable levels, thus generally requiring that the user signature profile be recreated. This is inconvenient, and further the rate of change in an individual's signatures varies from individual to individual therefore addressing such changes in prior art signature authentication systems is difficult. One of the aspects of the present invention is that the signature profile of the user is updated over time to accommodate changes to the user's signature. This occurs without the need for user initiation.

The present invention, in one aspect thereof, is best understood as consisting of three interrelated processes: (1) data acquisition, (2) data analysis and (3) data authentication. As explained herein, these processes are implemented, in accordance with the present invention, as a computer program embodying such processes, and also as a computer or system that is includes a computer device including or being linked to the described computer program.

### Data Acquisition

A user is given a writing instrument that includes a grip force measurement means, and also optionally an axial force measurement means. A specific example of such a writing instrument is provided below. The writing instrument is operable to acquire data required to provide the total grip profile described above. Specifically, a plurality of sensors is preferably arranged substantially throughout an area on the writing instrument where a significant portion of the population is likely to contact when writing with the writing instrument.

Preferably, the user writes using the writing instrument the same words multiple times (whether it is their signature or the same word). In a particular embodiment of the present invention, a data collection routine is defined by operation of the writing instrument, or the writing instrument linked to a computer, wherein the data collection routine is operable over multiple writing instances to capture time, x-position, y-position and optionally axial force data. Once a sufficient number of samples has been collected (best understood as a statistically significant number of samples for the purpose of defining the functional model described herein), measured data is stored to a database. In a particular aspect of the present invention where axial force is measured in additional to grip force, the grip force time period is synchronized with the axial force data and all data is saved in the database.

### Data Analysis

The biometric data obtained through the described data acquisition is then analysed to define the functional model. In accordance with the present invention, the functional model is established based on statistical analysis of the biometric data. The grip force curves are optionally tested and smoothed to reduce noise interference. The mean of the grip force curves is calculated, and optionally mismatched curves are removed from the set of biometric data. The interquartile range (IQR) of the point-by-point differences of the grip force curves of the signatures obtained during data acquisition is measured. A subset of the signatures measured may be randomly selected, and the functional model is obtained based on a distribution of the IQR of the differences of each sample signature to the mean. The functional model of the user's signature thus obtained provides the user's handwriting profile in accordance with the present invention. If the test signature's or test writing's interquartile range of point-by-point difference falls within the distribution of IQR of the differences of the real model for the individual, then the signature is flagged as real, otherwise, as a forgery. This algorithm is more sensitive yet less specific than a combined grip force and axial force algorithm. The utilization of the combined axial and grip force algorithm leads to a more specific analysis (i.e. more rigid criteria for authentication).

It should be understood that this signature profile is easily updated by recalculating the functional model sporadically or on an ongoing basis. It is possible that an individual's signature grip force pattern or axial force pattern changes with time and therefore, as deemed appropriate, the individual may be required to provide a new set of signatures for their functional model. This ensures the robust detection of real and forged signatures and is fast and user-friendly.

### Data Authentication

A new instance of handwriting is obtained, and this is analyzed to obtain the biometric data for that new instance. This biometric data is compared to the handwriting profile calculating the point-by-point differences between the new instance of handwriting to the mean of the functional model for the user, and the IQR of these point-by-point differences are obtained (“new IQR”). The new IQR is then compared to the IQR distribution of the functional model. If the new IQR is within the distribution the handwriting is authenticated, if it is not, it is rejected i.e. it is forged.

One possible option for the profile update is to add a signature to the existing database whenever the signature is found to be real. In order to prevent an increasing number of signatures in the database, a signature with the earliest date entry into the database is erased and a new signature is added. However, to prevent a possible hacking of the system, a constraint should be added e.g., the new signature has to resemble the existing model with the accuracy greater than 98%.

It should be pointed that the x-position and y-position are never directly used in the calculations. They are used in the signature parameter extraction step to plot the signatures of the individual and extract axial force and grip force for an individual signature.

There is no set number of required instances of handwriting to create the functional model, what is required is a sufficient number based on the desired specificity or sensitivity, as evident to a person with ordinary skills in the art. Based on operation of the invention described, it is generally recommended that a person provide a large number of handwriting samples in order to establish a more accurate model. The specific number of handwriting samples depends on the system constraints such as memory, speed, accuracy and etc.

From the description of the systems so far, it is clear that a pen specially fitted with various sensors is required. However, a special writing surface is not required.

### Example in Operation

The present invention is illustrated using an example in operation.

An individual participant is requested to sign a plurality of signatures (the signature being an example of an instance of handwriting, but it should be understood that the present invention applies to handwriting generally and not just signatures). These signatures' parameters are extracted as the real files for that participant. The parameters: time, x-position, y-position, and axial force (optional) are saved in a separate file from the grip force but both are time stamped for easy synchronization.

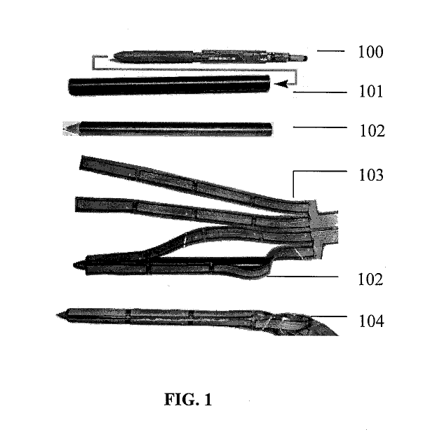

FIG. 1 illustrates a particular implementation of an instrumented writing utensil to record biometric information with respect to an individual's signature. A writing instrument (100) is inserted into a round tube (101) to complete the writing utensil (102). The pressure sensors (103) mounted on the writing utensil (102) are, in one instance of the present invention, model 9811 Tekscan sensors. Pressure values from 32 sensors (4 sensor strips*8 sensor pads per strip) per sampling period are recorded by the F-scan software. The sampling period was set to 0.0107 second per sample. Other sensors, sampling periods and recording software are contemplated in other implementations of the present invention.

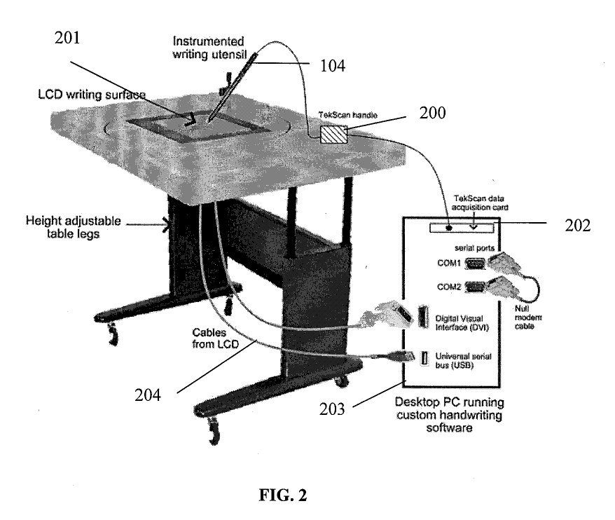

FIG. 2 illustrates a particular implementation of a set up to record biometric information with respect to an individual's signature. In a particular example of implementation of the present invention, the instrumented writing utensil (104) can be used to write signatures on a LCD writing surface (201). The instrumented writing utensil (104) is connected to a TekScan handle (200) in this instance of the present invention. The LCD writing surface is connected via cables (204) to a computer (203). The TekScan handle (200) is also connected to the computer (203) via the TekScan data acquisition card (202).

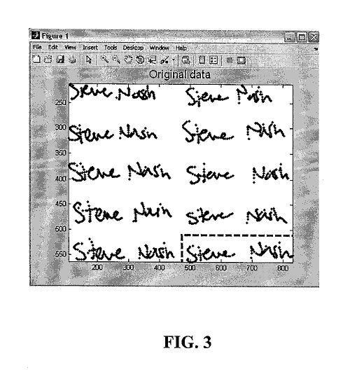

In order to begin synchronizing the axial and grip forces, grip force movie files are extracted, in this particular implementation of the invention. The resulting raw data may be parsed appropriately. Summing the grip force data yields the total grip force for each frame of time. Finally, the data can be synchronized from the original input file with the output of the summation. A new column of text file is then set to the synchronized grip data. The individual signatures and their parameters, an illustration of which is in FIG. 3, are extracted from the batch file. The time, x-data, y-data, axial force (optionally), and grip force for each signature are saved for further processing.

During data analysis, a functional model of the real signatures may be quantitatively tested with a test signature that may be real or forged and the results are recorded.

The present invention provides a process that simple, efficient, and user-friendly. In one aspect thereof, a user can simply pass a real signature file or a forged signature file into one function and the function is operable to flag the signature as real or forged.

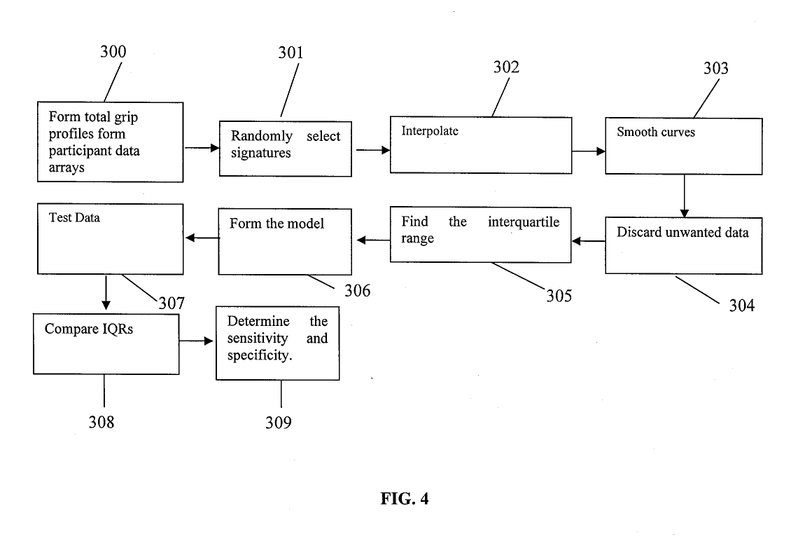

The data authentication step compares a test signature against a functional model of the real signatures. FIG. 4 illustrates a flow chart of the related algorithm operations, in one implementation of the present invention.

From the participant's profiles an array may be created with collected data (300). A subset of the signatures (301) may be selected. The system then interpolates all real grip force patterns to the same length and sets the mean of all grip for patterns to zero (302). All real grip force curves for the participant are corrected for unwanted phase variation or in other words, the temporal misalignment of curves (303), a known approach called curve registration. The curves may also be made smooth using Fourier transforms to filter noise from the grip force curves (304).

The mean curve of the registered curves may be plotted against each of the registered curves and if there is significant variation in pattern from the mean, the curve in question may be discarded from the set of real signatures (counted as a mismatch) (304).

The system is then operable to calculate the distribution of the interquartile range of the point-by-point differences for each curve with respect to the mean and remove significant outliers (305).

A subset of selected real signatures may then be selected as the functional model for that participant and the remaining real signatures may be tested against this model (306).

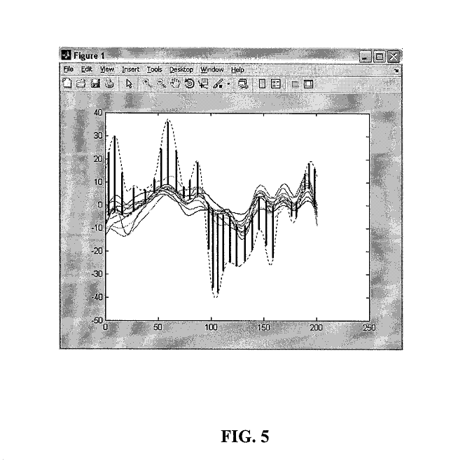

The statistic that differentiates between the real and forged signatures is the IQR of the point by point differences from the mean of the functional model. For each test signature, real or forged, the point by point differences from the mean of the model is identified as seen in FIG. 5. Then, the interquartile range of these differences (one number) is obtained (307).

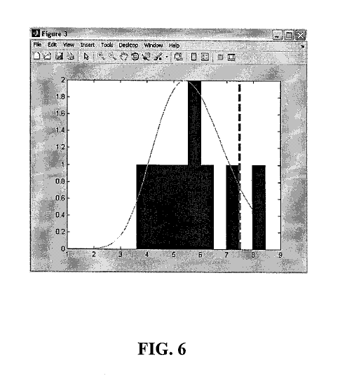

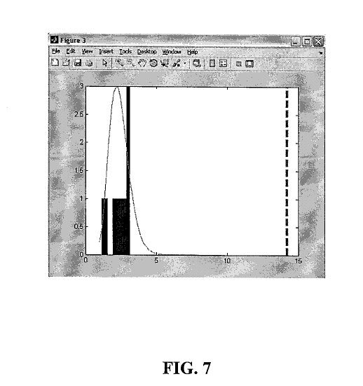

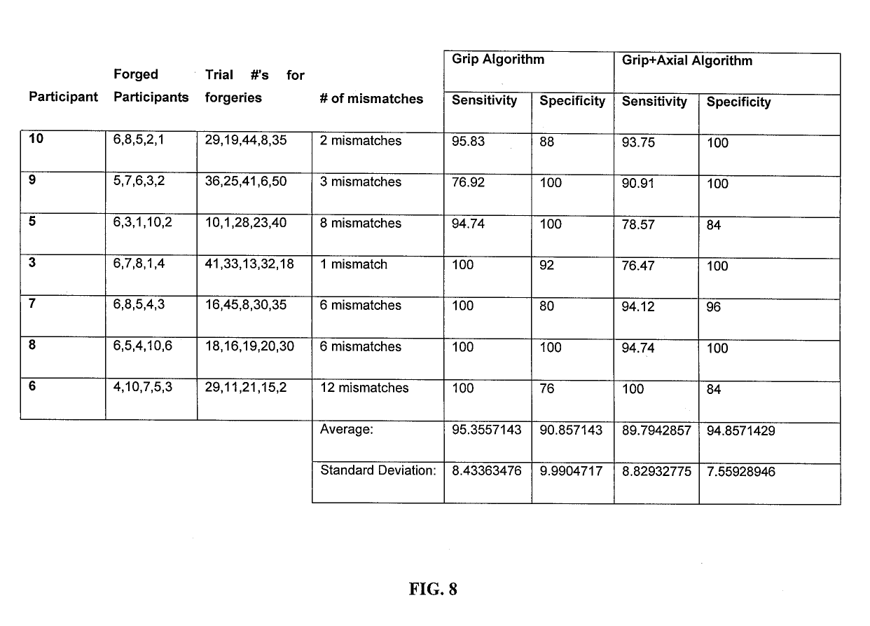

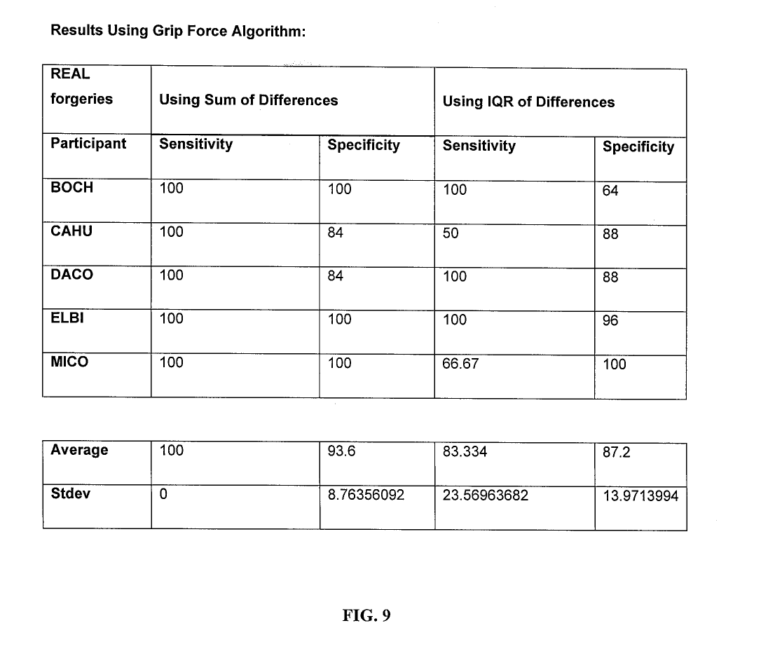

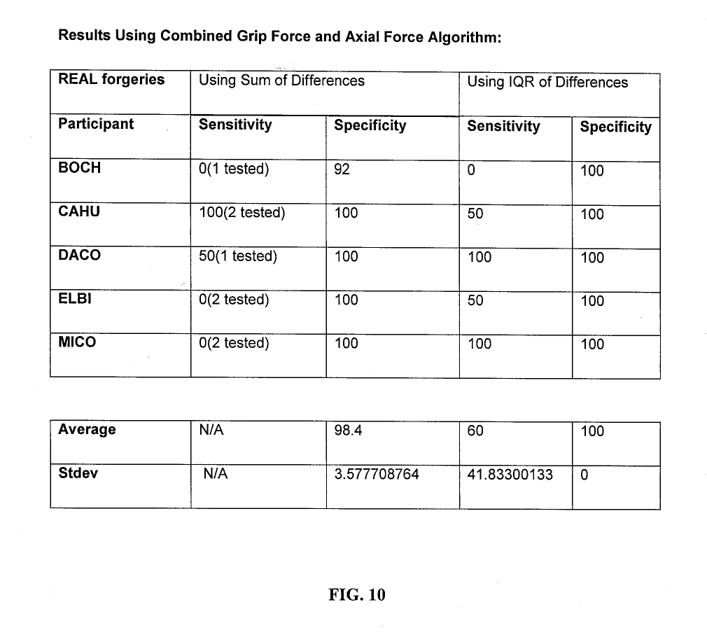

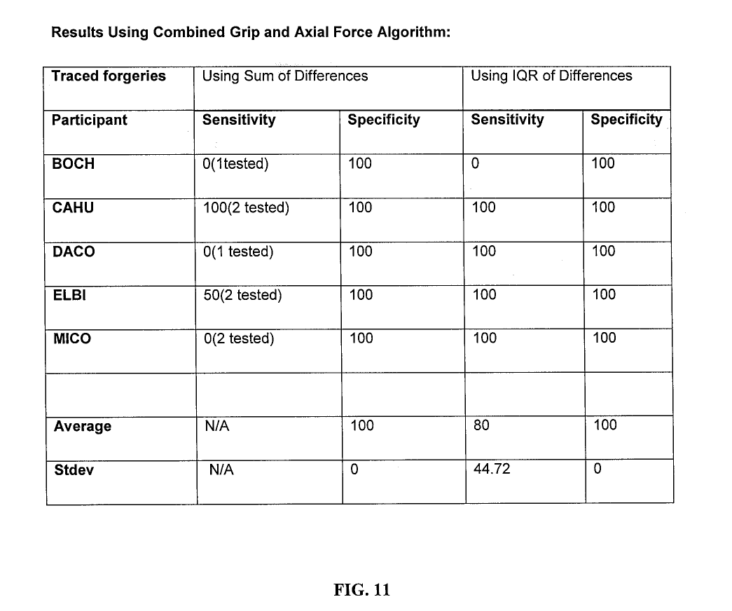

For the real model, the distribution of the interquartile range of the differences for the chosen subset signatures from the mean is obtained (308). If the IQR of the test signature falls within this distribution, then the signature is flagged as real as in FIG. 6. If it does not, the signature is identified as a forgery as in FIG. 7.

The real or forged signatures may then be passed into the model and the output is the sensitivity and specificity (309).

Sensitivity=TP/(TP+FN)−correctly identified real signatures

Specificity=TN/(FP+TN)−correctly identified forged signatures
TP—True Positive, TN—True Negative, FN—False Negative, FP—False Positive

The sensitivity and specificity are then averaged across all participants and the standard deviation is determined.

The present invention contemplates the variation of the authentication method using different statistics and approaches. In the example illustrated above, the IQR of the point-by-point differences of test signature profile vs. the model was used. However, it should be understood that similar authentication tests based on other criteria may be used such as:
Sum of point-by-point differences for test signature versus model
Median of the point-by-point differences of test signature profile vs. model
Mean of the point-by-point differences of test signature profile vs. model
Register the model, register the test signature with the mean curve of the registered model, calculate the difference between the last criterion number (energy of registration) for the mean with the test, if this number is below a critical number defined for that participant, the test signature is real
Register the model, find the mean and standard deviation of last criterion numbers for the 20 curves registered, register the test curve with the mean curve of the registered model, if the maximum last criterion number between the two falls within mean±standard deviation, the test is real
Calculate the adaptive Neyman statistic for the test curve vs. the registered model. Estimate the p-value of the computed test statistic value. If the p-value is close to 1, the two groups of curves came from the same distribution of random numbers and the test is flagged real.
Combine axial and grip forces for a more specific authentication. The algorithm will now utilize the axial force profiles as well. For the detection of a real signature, both axial and grip force patterns must meet the algorithm requirements for authentication.

### Results of Example in Operation:

To illustrate the operation of the present invention, all participants with consistent real grip signature profiles were tested. The results were obtained using both the grip profile algorithm and using the combination of the grip profiles and the axial force profiles. The results are as follows:

| | Forged | Trial #'s for | # of | Grip Algorithm | | Grip + Axial Algorithm | |
|---|---|---|---|---|---|---|---|
| Participant | Participants | forgeries | mismatches | Sensitivity | Specificity | Sensitivity | Specificity |
| 10 | 6, 8, 5, 2, 1 | 29, 19, 44, 8, 35 | 2 mismatches | 95.83 | 88 | 93.75 | 100 |
| 9 | 5, 7, 6, 3, 2 | 36, 25, 41, 6, 50 | 3 mismatches | 76.92 | 100 | 90.91 | 100 |
| 5 | 6, 3, 1, 10, 2 | 10, 1, 28, 23, 40 | 8 mismatches | 94.74 | 100 | 78.57 | 84 |
| 3 | 6, 7, 8, 1, 4 | 41, 33, 13, 32, 18 | 1 mismatch | 100 | 92 | 76.47 | 100 |
| 7 | 6, 8, 5, 4, 3 | 16, 45, 8, 30, 35 | 6 mismatches | 100 | 80 | 94.12 | 96 |
| 8 | 6, 5, 4, 10, 6 | 18, 16, 19, 20, 30 | 6 mismatches | 100 | 100 | 94.74 | 100 |
| 6 | 4, 10, 7, 5, 3 | 29, 11, 21, 15, 2 | 12 mismatches | 100 | 76 | 100 | 84 |

| | | | | |
|---|---|---|---|---|
| Average: | 95.3557143 | 90.857143 | 89.7942857 | 94.8571429 |
| Standard Deviation: | 8.43363476 | 9.9904717 | 8.82932775 | 7.55928946 |

Five participants were recruited to provide real signatures and five other participants forged the real signatures. Ten real signatures were collected from each real participant and 25 forgeries to test the models. Five of the real signatures were used to form the model and there were often 2-3 mismatches in the real signatures. Therefore, due to the few number of real tests for the model, the sensitivity numbers for these trials are not robust. The following are the results of using the grip profile algorithm on these participants:

### Results Using Grip Force Algorithm:

| REAL | Using Sum of | | Using IQR of | |
|---|---|---|---|---|
| forgeries | Differences | | Differences | |
| Participant | Sensitivity | Specificity | Sensitivity | Specificity |
| BOCH | 100 | 100 | 100 | 64 |
| CAHU | 100 | 84 | 50 | 88 |
| DACO | 100 | 84 | 100 | 88 |
| ELBI | 100 | 100 | 100 | 96 |
| MICO | 100 | 100 | 66.67 | 100 |
| Average | 100 | 93.6 | 83.334 | 87.2 |
| Stdev | 0 | 8.76356092 | 23.56963682 | 13.9713994 |

For a more specific authentication, the combined algorithm (axial and grip) was also used for verification on the above participants:

### Results Using Combined Grip Force and Axial Force Algorithm:

| REAL | Using Sum of | | Using IQR of | |
|---|---|---|---|---|
| forgeries | Differences | | Differences | |
| Participant | Sensitivity | Specificity | Sensitivity | Specificity |
| BOCH | 0(1 tested) | 92 | 0 | 100 |
| CAHU | 100(2 tested) | 100 | 50 | 100 |
| DACO | 50(1 tested) | 100 | 100 | 100 |
| ELBI | 0(2 tested) | 100 | 50 | 100 |
| MICO | 0(2 tested) | 100 | 100 | 100 |
| Average | N/A | 98.4 | 60 | 100 |
| Stdev | N/A | 3.577708764 | 41.83300133 | 0 |

Similar to the case with signing a common word, the specificity improves when a combined algorithm is used and the sensitivity suffers (However, as mentioned, the sensitivity numbers in the last two tables are not indicators of the effectiveness of the algorithm on real signatures due to the small number of real tests)

We also gathered traced forgeries of the real signatures and tested both algorithms on these signatures. The results:

### Results Using Combined Grip and Axial Force Algorithm:

| Traced | Using Sum of | | Using IQR of | |
|---|---|---|---|---|
| forgeries | Differences | | Differences | |
| Participant | Sensitivity | Specificity | Sensitivity | Specificity |
| BOCH | 0(1tested) | 100 | 0 | 100 |
| CAHU | 100(2 tested) | 100 | 100 | 100 |
| DACO | 0(1 tested) | 100 | 100 | 100 |
| ELBI | 50(2 tested) | 100 | 100 | 100 |
| MICO | 0(2 tested) | 100 | 100 | 100 |
| Average | N/A | 100 | 80 | 100 |
| Stdev | N/A | 0 | 44.72 | 0 |

With an average sensitivity value of 95.36% and average specificity of 90.86%, this grip signature authentication algorithm which exploits grip force pattern proves reliable and functional. The combined grip and axial force algorithm provides a more specific authentication with a sensitivity of 89.79% and a specificity of 94.86%.

It should be understood that the present invention may be implemented as several different products. One possible application of the described technology involved signature authentication at financial institutions. The technology can be used in addition to a human verifier and/or more complex biometric authentication systems to provide a more robust decision process. A second possible application of the proposed technology is to use in a rehabilitation setting, where one would track changes of a person's profile and a level of possible improvements.

It will be appreciated by those skilled in the art that other variations of the embodiments described herein may also be practiced without departing from the scope of the invention. Other modifications are therefore possible. For example, one might choose to store the grip force and axial force data in the pen during the data collection. The data then would be transferred to a computer when the pen is connected to the machine. Another modification entails wireless transmission of the data to the machine which would analyze the data.

What is claimed is:

1. A method of associating handwriting with an individual, or authenticating a document or transaction based on handwriting of one or more individuals, comprising the steps of:
(a) collecting by operation of a handwriting instrument, biometric data from a plurality of instances of handwriting of at least one individual, such biometric data including grip pressure and optionally including axial pressure, so as to create a set of handwriting biometric data elements;
(b) modeling the handwriting biometric data elements to create, or facilitate the creation of, a functional characteristic model for the handwriting of each of the at least one individual; and
(c) associating each of one or more target instances of handwriting with an individual associated with such handwriting based on the functional characteristic model, and optionally based on such association(s) authenticating a document or transaction.

2. The method of claim 1 wherein the biometric data is obtained for an area, or substantially all of an area, where the individual contacts the handwriting instrument during writing.

3. The method of claim wherein the handwriting is a signature.

4. The method of claim 1 wherein the functional characteristic model is based on statistical analysis of the handwriting biometric data elements.

5. The method of claim 1 wherein the functional characteristic model is based on a distribution of the interquartile range of point-to-point differences of a plurality of instances of handwriting to the mean therefor.

6. The method of claim 5 wherein the functional characteristic model includes adjustability of specificity and/or sensitivity.

7. A handwriting apparatus comprising:
an array of sensors that enable the capture of handwriting biometric data across a plurality of instances of handwriting of at least one individual, such array being operable to sense grip pressure and optionally axial pressure, wherein said array is disposed in substantially all of the area of the surface of a handwriting instrument where a user is likely to contact the handwriting instrument during writing, wherein the array is connected or connectable to a computer for analyzing the handwriting biometric data, and enabling based on such analysis association of handwriting with an individual, or authentication of a document or transaction based on handwriting of one or more individuals.
